(19) United States
(12) Patent Application Publication
(10) Pub. No.: US 2018/0253928 A1
(43) Pub. Date: Sep. 6, 2018

(54) AUTOMATED DEVICE AND METHOD FOR RENTING AND SHARING EQUIPMENT

(71) Applicant: Umbracity Innovations Inc., Vancouver (CA)

(72) Inventors: Babak Assadsangabi, Vancouver, BC (CA); Amir Entezari, Vancouver, BC (CA)

(73) Assignee: Umbracity Innovations Inc., Vancouver, BC (CA)

(21) Appl. No.: 15/754,234

(22) PCT Filed: Aug. 22, 2016
(86) PCT No.: PCT/CA2016/050986

§ 371 Date: Feb. 21, 2018

Related U.S. Application Data
(60) Provisional application No. 62/208,645, filed on Aug. 22, 2015.

(51) Int. Cl. G07F 17/00; G06Q 30/06; G07F 11/64; G07F 7/06; G06Q 20/18

(52) U.S. Cl. CPC G07F 17/0042; G06Q 30/0645; G06Q 20/18; G07F 7/06; G07F 11/64

(57) ABSTRACT

The present application provides an automated device, including a corresponding network system, that dispenses and receives shared/rental equipment such as umbrellas, sporting equipment, safety accessories and consumer electronics. The device preferably has a mechanical guide that is used to hold the shared/rental equipment or its packaging by using an anchoring structure. A tracking system can be used to track the return and rental processes. Ideally, the device utilizes a central database which can be accessed through internet for administrating the transactions (e.g. rental and return processes) with the device as well as tracking the users, inventory and locations.

### FIELD

This invention relates to the field of automated and unattended vending machines. More specifically, the invention relates to a method and device that enable rental and/or sharing of smaller, portable equipment.

### BACKGROUND

There has been an increasing interest in the sharing economy and collaborative consumption in recent years which enables shared use of goods/assets that otherwise must be purchased by each individual. Shared usage of cars (car2go) and bicycles (bike share programs) are successful examples of collaborative consumption. Most of the current sharing companies focus on sharing of assets with large footprints through automated systems which do not require human supervision. However, there has been little advancement in the development of technologies that can enable sharing/rental of assets with small to medium footprints through automated vending machines. For example, WO2006116112 discloses an automatic vending machine for renting DVDs. U.S. Pat. No. 9,320,364 discloses a vending machine for renting helmets for bike share programs. US patent application 2012/0248183 describes a vending machine that rents out cellphones, ipad or other electronic device for temporary use. Other devices are disclosed in U.S. Pat. No. 6,125,985.

Most of automated vending machines can only dispense consumables/equipment and hence cannot be used as rental and/or sharing machines which allow items to be returned. Moreover, many automated rental kiosks incorporate large numbers of moving parts and servo motors, which results in high manufacturing and maintenance costs of such systems.

Further, current vending machine designs do not allow for tracking/managing of their inventory in a way that is suitable for sharing and rental purposes. There is a need for a device that manages and tracks the movement and storage of inventory, particularly with items having a smaller footprint.

This background information is provided for the purpose of making known information believed by the applicant to be of possible relevance to the present invention. No admission is necessarily intended, nor should be construed, that any of the preceding information constitutes prior art against the present invention.

### SUMMARY

An object of the present invention is to provide an automated rental/sharing vending machine with at least one entry and dispensing ports that can track rental/shared items.

In accordance with an aspect of the present invention, there is provided a device for releasably retaining one or more items for shared distribution, the device comprising: a guide for supporting the one or more items; an anchoring mechanism for engaging with the guide; and a scanning system for scanning the one or more items prior to and after distribution of the one or more items to one or more users, and for tracking the one or more items.

The guide in the device can be a mechanical guide. Further, the anchoring mechanism can be integral to each of the one or more items or is releasably engagable with the one or more items, which can be secured in the device by a locking mechanism.

The tracking of the one or more items may include counting the distribution of the one or more items by a counting mechanism.

Interactions with the kiosk or kiosk status may be controlled or managed by embedded supervisory software.

The device can further comprise a communication module to transmit and receive information to and from a remote database. Additionally, the device can comprise a payment system to accept fees from users, which as stated above can be integral with the device or accessible through a remote mobile application. Payment can reflect rental fees or reservation charges.

Ideally, the device can include an enclosure to store the one or more items.

The device can incorporate a tracking system which uses Ultra High Radio Frequency technology that can detect the presence or removal of the one or more items within the device.

In accordance with another aspect of the present application, there is provided a method of providing one or more items for shared distribution from a device, the method comprising the steps of: receiving a request from a user to obtain the one or more items from the device; authenticating the user by querying a database to where registered users information is stored to determine if the user is a registered user, wherein if the user is not registered, the database informs the user to register, and if the user is registered, the database sends a lock release command to the kiosk to allow the user to remove the one or more items from the device; scanning, identifying and counting the one or more items from the device to associate a user's account with the one or items, and initiating a period of time for use of the one or more items obtained from the device; sending a confirmation message to the user; wherein after the one or items is returned to the device, the item is received by the device, scanned and counted, and the user's account is disassociated from the one or more items returned to the device, thereby terminating the period of time for use of the one or more items, and wherein a further confirmation message is sent to the user. The request and confirmation messages can be received through a user information on the device or through a mobile application.

The present invention relates to a device and method that enable rental and/or sharing of small equipment such as, for example, umbrellas; however, various other items, such as sporting equipment (including but not limited to golf clubs, and tennis or squash rackets), consumer electronics including (but not limited to) cell phones and portable chargers, portable research laboratory equipment and supplies including (but not limited to) multimeters, hand-held sensors and medical lab consumables, and safety equipment/accessories (for example, safety helmets for bikes). Ideally, the user can either pay or register for the use of the item through an interface on the device or through a remote mobile application.

The present invention relates to the sharing or rental of equipment/assets with small to medium volume such as those mentioned above, through an automated device, such as a vending machine managed by a supervisory software and database system which interacts with the device using an internet connection.

In accordance with certain aspects of the present invention, a registered user may be first identified by the device and then the user will be able to remove one or more items with unique IDs that have already been identified by the scanning system. To return, the user inserts the rented item and the scanning system at the return port will identify the “ID code” and the return process is completed. In one embodiment, the item rented is an umbrella. In other embodiments, the item may include sporting equipment, consumer electronics, laboratory supplies, safety items, or other items. The device may be used to identify when a piece of equipment has been borrowed and to whom it has been rented. Also, upon return of the equipment the device may be used to identify the returned equipment as well as the user.

In this application, specific exemplary embodiments have been provided to assist in the explanation and demonstration of some aspects of the invention. However, the invention is not limited in scope to those specific exemplary embodiments, and alternative materials, designs, fabrication methods and embodiments are possible.

### BRIEF DESCRIPTION OF THE FIGURES

For a better understanding of the present invention, as well as other aspects and further features thereof, reference is made to the following description which is to be used in conjunction with the accompanying drawings, where:

FIG. 1 provides an exemplary design of a mechanical guide, in accordance with one aspect of the present invention, that engages with a rental/shared item.

FIG. 2 provides an alternative exemplary design for a mechanical guide, in accordance with one aspect of the present invention, that engages with the rental/shared item.

FIG. 3 provides an example of anchoring structures integrated into the body of the rental/shared equipment (e.g. umbrella).

FIG. 4 provides an alternative exemplary embodiment of an anchoring structure attachable to the rental/shared equipment, and a mechanical guide to hold the rental/shared equipment.

FIG. 5 illustrates an exemplary scanning/tracking system component that scans the rented and returned items from/to the device.

FIGS. 6A, 6B and 6C provide exemplary embodiments in accordance with the present invention of one locking and counting mechanism using different viewing angles.

FIG. 7 illustrates exemplary venting holes for humidity control inside one embodiment of a device in accordance with the present invention.

### DETAILED DESCRIPTION

Unless defined otherwise, all technical and scientific terms used herein have the same meaning as commonly understood by one of ordinary skill in the art to which this invention belongs.

As used in the specification and claims, the singular forms “a”, “an” and “the” include plural references unless the context clearly dictates otherwise.

The term “comprising” as used herein will be understood to mean that the list following is non-exhaustive and may or may not include any other additional suitable items, for example one or more further feature(s), component(s) and/or ingredient(s) as appropriate.

In accordance with one aspect of the present invention, there is provided a device, such as a vending machine, comprising rental or shared equipment and a supervisory software and database system. In certain embodiments, the device comprises the following components:

Physical/Mechanical Guide:

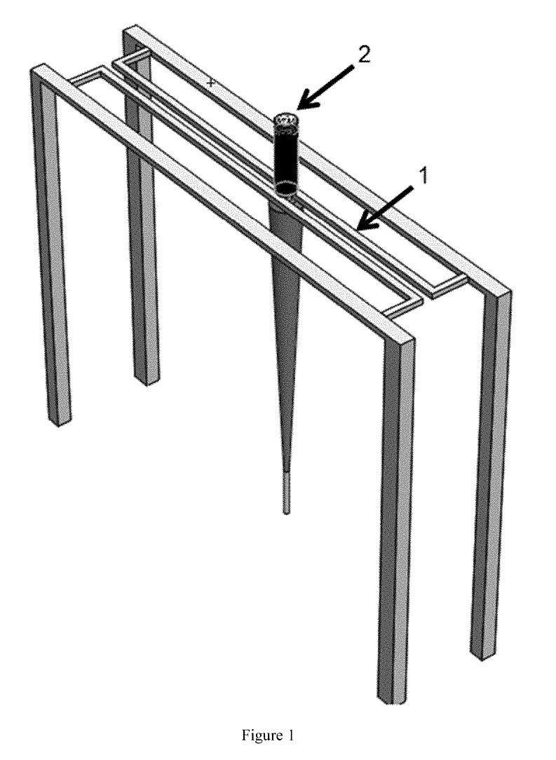

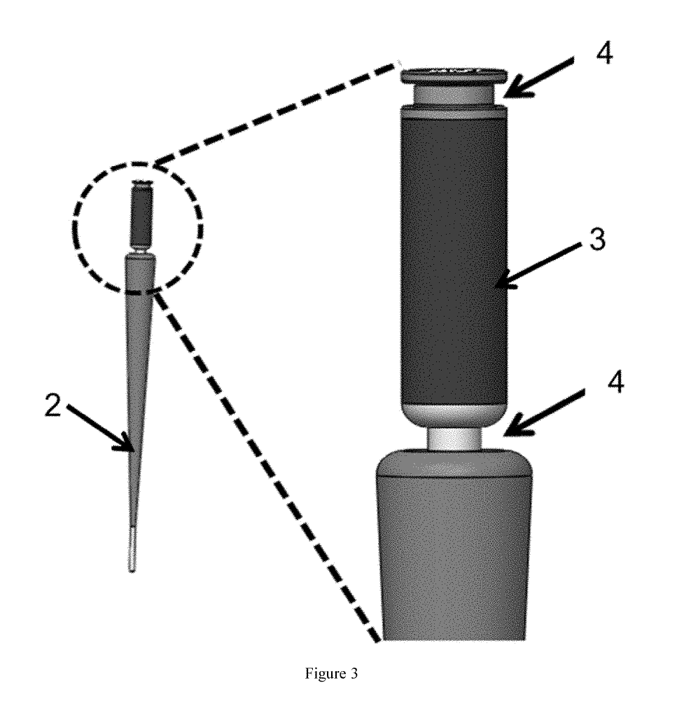

FIG. 1 illustrates an exemplary device for holding and retaining a unit of rental equipment. At least one physical/mechanical guide (1) is provided that supports the rental/shared equipment (2) or its packaging. In some embodiments of the present invention, the movement of the rental/shared equipment (2) along the at least one guide (1) may be enabled by manual movement applied by the hand of kiosk user. To enable such movement, a certain portion of the rental/shared equipment or its casing or anchoring structure may be positioned outside of the device's physical boundary. The certain portion of the rental/shared equipment (2) includes, but is not limited to, all or part of the handle (3) or casing or anchoring structure (4), as illustrated in FIG. 3.

The guide may be fabricated by various geometries including but not limited to bringing two straight or round bars (5) in close approximation to one another. The opening distance in the mechanical guide depends on the anchoring structure shape/dimensions of the rental/shared equipment (2) and may be determined in a way to match with the anchoring structure of the guide (such as by shape and size, for example).

As a non-limiting example, in one embodiment, an umbrella with a shaft diameter of 2 cm and handle diameter of 5 cm would typically require an opening of 2 to 5 cm in order to hold the umbrella in the guide, while still allowing for unimpeded movement of the umbrella along the guide during the rental or return process.

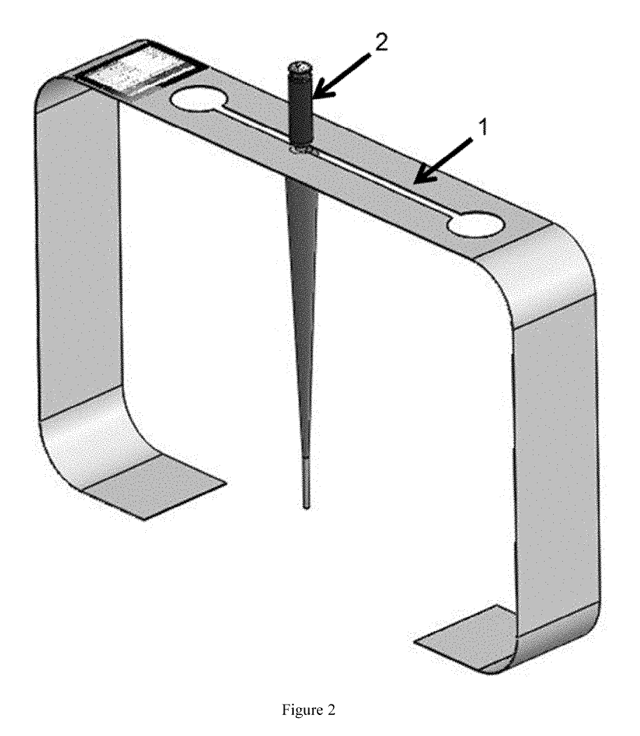

FIG. 2 shows an alternative embodiment of the device in accordance with the present invention. In this example, an opening with straight and/or circular and/or combination of both is cut through a sheet of metal or plastic to create a guide.

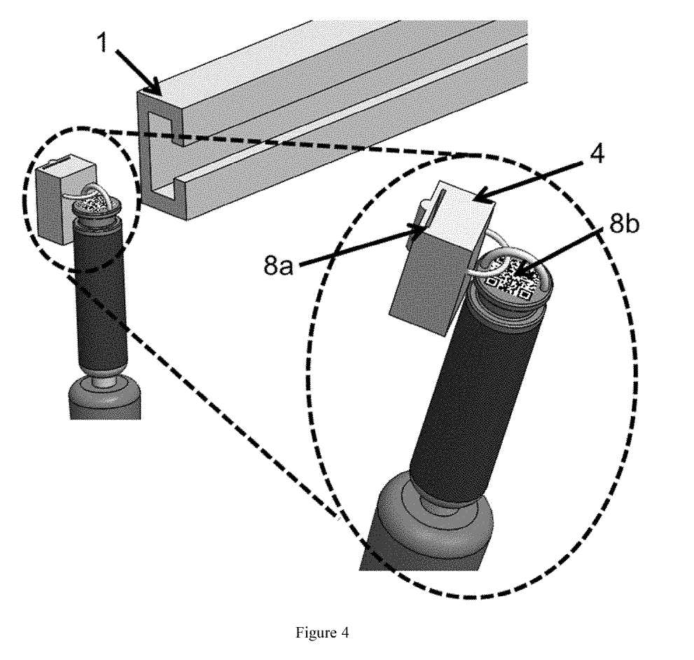

The casting or molding can be used to create the guide in the desired material. For example, extrusion of metal or plastic may be used to provide the guide structure. For example, FIG. 4 illustrates one mechanical guide (1) which can be achieved by extrusion of different materials. Various materials may be used to fabricate the mechanical guide. These can include, but are not limited to, metals such as steel and aluminum, or plastics such as polyethylene. Multiple combinations of materials may also be used to fabricate the mechanical guide. In one embodiment, the material includes aluminum. Preferred materials are those that are corrosion resistant, low cost, easy to form/cut, and with sufficient mechanical strength to withstand the forces from the weight of the rental/shared equipment (1) and other applied forces from the device users.

In one embodiment, each device comprises a single guide. However, depending on desired number of items and their sizes, alternative embodiments of the device could include more than one guide could be incorporated into the device to increase the capacity of each individual unit.

In one embodiment, each device of the present invention may include a single entry and exit port. However, depending on the usage of the device, alternative embodiments of the device can include more one exit and entry ports (6) to allow the users to rent and/or return at those additional ports.

Anchoring Structure:

As illustrated in FIG. 3, the rental/shared equipment (2) typically includes an anchoring structure (4) that engages with the mechanical guide and can be moved along the guide (1). In one embodiment, one anchoring structure (4) may be attached or integrated within the rental/shared equipment (1). However, in alternative embodiments, multiple anchoring structures may be attached or integrated in the rental/shared equipment.

The anchoring structure (4) may be realized by various geometries/methods including, but not limited to, creating the complimentary structure to the rental/shared equipment in the casing, handle (3) and/or packaging of the said rental/shared equipment (2). Alternatively, as illustrated in FIG. 4, the anchoring structure (4) may be attached to the casing/handle (3) and/or packaging of the rental/shared equipment (1).

Scanning Tracking System:

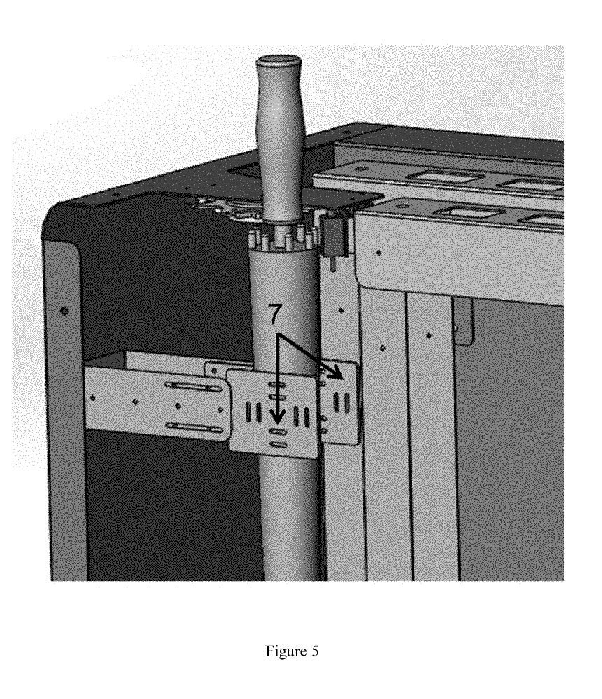

FIG. 5 illustrates an exemplary scanning/tracking system component (7) that scans the rented and returned items from/to the device. This component may be incorporated into the device. The scanning component may be based on RFID, barcode (laser), QR code scanner, Bluetooth or Video technology.

The scanning system may be installed in such a way that it can consistently scan the rented/shared and returned items from/to the device. Depending on the technology used for tagging the rental/shared equipment there can be one or more scanners at the entry and exit ports to make sure that the rented and returned items are scanned consistently. For example, if RFID tags are used for tagging the rental/shared equipment, the RFID readers are typically mounted in a way to ensure that when the rental/shared equipment is exiting or entering the device the tags on the equipment are read consistently.

There are various RFID technologies including but not limited to low frequency (e.g. 125 KHz), high frequency (e.g. 13.5 MHz) or ultra high frequency (higher than 300 MHz) that can be used for tracking equipment in accordance with the present invention. Depending on the technology used, the read range for the RFID tag may be in the range 1 cm to one or more metres. Therefore, the readers may be adjusted in a way to make sure that the tags are read consistently.

In one embodiment, passive RFID tags with 125 KHz frequency may be used in conjunction with a scanning system composed of two coil antennas placed parallel to each other in a configuration that allows for the rental/shared equipment to be passed between the antenna coils. This configuration may allow for consistent reading of the tags in more than one direction.

As shown in FIG. 4, one embodiment shows that the RFID tag can be attached the anchoring structure (4) so that the tags is always mechanically aligned with the scanning antenna coil as the rental/shared equipment exits or being returned to the device.

Identification Component:

An identification component (8a, 8b) including, but not limited to, RFID tags and barcodes, QR codes, or Bluetooth modules, can be attached to the rental/shared equipment for tracking and inventory control purposes. These may then be scanned by the tracking system. FIG. 4 shows two possible identification components (8a, 8b) which can be used.

Locking Mechanism:

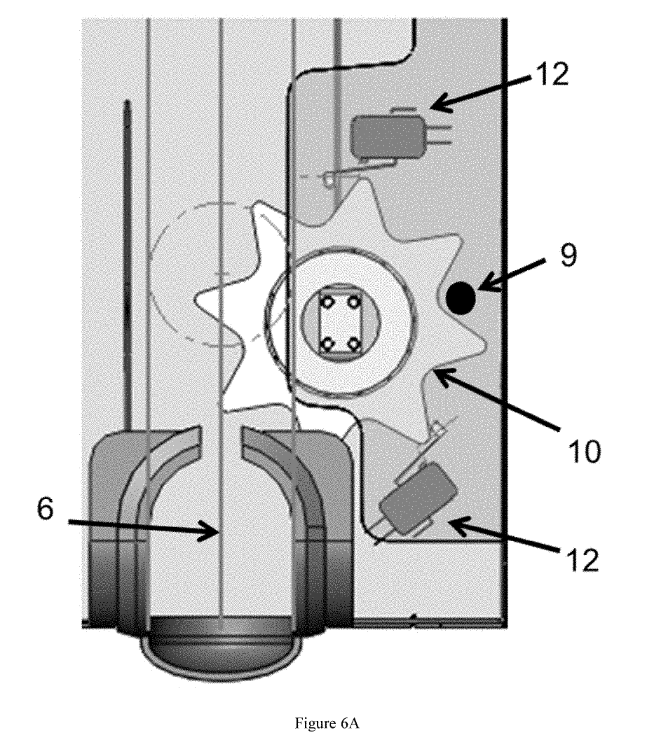

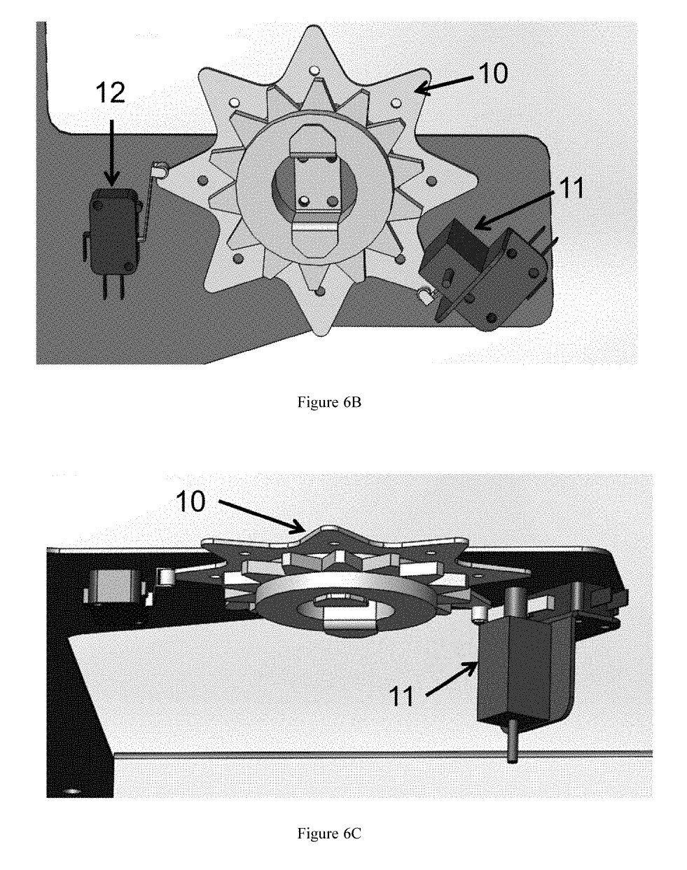

FIGS. 6A-C show exemplary embodiments of a locking mechanism which can be used in the present invention. The device includes a locking mechanism (9) that controls the access to the entry and exit return ports (6).

The entry and exit return ports (6) typically consist of a locking mechanism (9) which can be in different forms. In one embodiment shown in FIG. 6A, a ratchet mechanism (10) which is free to rotate in one direction but not free to turn in the reverse direction, may be employed. As shown in FIG. 6B, the ratchet mechanism may also be restricted to turn in one direction (free-to-turn direction) by using an electronic lock (11) based on a solenoid with movable rod that engages with the ratchet wheel and does not allow it to turn and the solenoid can be actuated so as to let the ratchet wheel to turn in the allowed direction and the user can remove the rental/shared equipment.

Counting Mechanism:

FIGS. 6A and 6C illustrate one embodiment in which the device of the present invention may include a counting mechanism (12) that counts the number of returned and rented items. The counting mechanism, for example, may use two mechanical and/or optical switches that engage with the ratchet wheel. As the ratchet turns the switches are turned on and off by the action of ratchet wheel teeth. By counting the number of switches clicks the number of rented/returned equipment can be determined.

Alternatively, counting action may be obtained by the scanning component as the rented/returned equipment is passed over the scanner by the user during rental and/or return of the equipment.

Powering Unit:

The device typically includes a powering unit which supplies the electrical energy to the device. In one embodiment, the power source is from city electrical grid sockets. In other embodiments, power to the device could be supplied by different means including, but not limited to, a rechargeable battery, or solar cells (e.g. for outdoor use).

Communication:

In certain embodiments, a device as described herein includes a communication component that enables exchanging data/device status over the internet to a supervisory backend software and database system and/or user's mobile phones applications in order to update the information related to user profile and/or kiosk status.

Software:

a) Embedded Processing Unit:

The present device may include an embedded processing unit system that locally manages the interactions with the device and corresponds accordingly depending on the user commands such as requests for rental, returning of the shared/rental equipment. Also, the embedded processing unit may be used to monitor the status of different hardware kiosk components and report them to the supervisory software.

b) Supervisory Software:

The system may include supervisory software and a database that wirelessly/remotely manages interactions with the device, while also tracking the rental items and status of the device.

c) Mobile Software:

In one embodiment, the rental process includes mobile software downloadable by users that enables them to know the status of the device's inventory and their locations. Also, users can utilize the software to interact with the device and rent equipment from a nearby device.

Payment/Registration:

The present device may include a payment/registration system that enables users to register/pay rental fees associated with using the device. In one embodiment, a payment option includes credit cards. Alternatively, other payment options can be used including, cash (coins or bills), and/or mobile payments through mobile software and phones and websites, for example.

Temperature/Waterproofing:

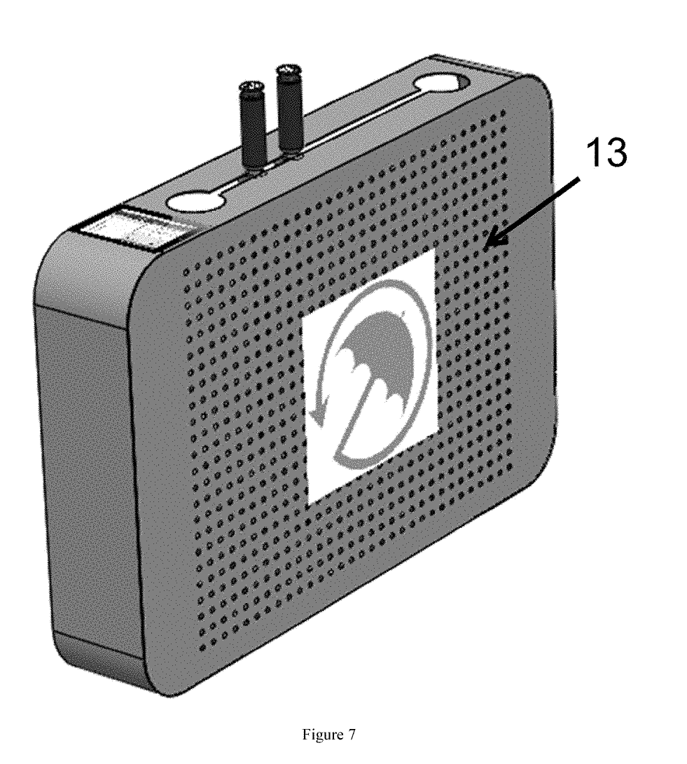

In some embodiments of the present invention, the device may be equipped with means to control humidity and/or temperature from the rented/shared items. As illustrated in FIG. 7, various methods could be used including, but not limited to, temperature and humidity sensors coupled with heaters and fans to control the temperature or air venting holes (13) in the device to accommodate humidity and temperature control.

In some embodiments of the present invention, the device may be designed to prevent water ingress due to rain, and allow it to be placed outdoors. In one embodiment, overhead shades on top of the device can be used. In alternative embodiments, other solutions can be used, including, but not limited to, use of water removal channels on top surface of the device enclosure, use of water resistant coatings and materials for the kiosk enclosure, incorporation of a slight slope to the top surface of the device enclosure to enhance water removal and also improving movement of the rental/shared equipment along the mechanical guide, and/or inclusion of a removable cover for the device segments that needs to protected from rain or sun light. Each of these designs may be used alone, or one or more of these designs may be used in combination.

All publications, patents and patent applications mentioned in this Specification are indicative of the level of skill of those skilled in the art to which this invention pertains and are herein incorporated by reference to the same extent as if each individual publication, patent, or patent applications was specifically and individually indicated to be incorporated by reference.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

The embodiments of the invention in which an exclusive property or privilege is claimed are defined as follows:

1. A device for releasably retaining one or more items for shared distribution, the device comprising:
a guide for supporting the one or more items;
an anchoring mechanism for engaging with the guide; and
a scanning system for scanning the one or more items prior to and after distribution of the one or more items to one or more users, and for tracking the one or more items.

2. The device of claim 1, wherein the guide is a mechanical guide.

3. The device of claim 1 or 2, wherein the anchoring mechanism is integral to each of said one or more items or is releasably engagable with the one or more items.

4. The device of any one of claims 1 to 3, wherein the one or more items are secured in the device by a locking mechanism.

5. The device of any one of claims 1 to 4, wherein the tracking of the one or more items includes counting the distribution of the one or more items by a counting mechanism.

6. The device of claim 1, wherein the interactions with the kiosk or kiosk status is controlled or managed by embedded supervisory software.

7. The device of any one of claims 1 to 6, further comprising a communication module to transmit and receive information to and from a remote database.

8. The device of any one of claims 1 to 7, further comprising a payment system to accept fees from users.

9. The device of claim 8, wherein the fees are rental fees or reservation charges.

10. The device of any one of claims 1 to 9, further comprising an enclosure to store the one or more items.

11. The device of any one of claims 1 to 10, wherein the tracking uses Ultra High Radio Frequency technology that can detect the presence or removal of the one or more items within the device.

12. A method of providing one or more items for shared distribution from a device, the method comprising the steps of:
receiving a request from a user to obtain the one or more items from the device;
authenticating the user by querying a database to where registered users information is stored to determine if the user is a registered user, wherein if the user is not registered, the database informs the user to register, and if the user is registered, the database sends a lock release command to the kiosk to allow the user to remove the one or more items from the device;
scanning, identifying and counting the one or more items from the device to associate a user's account with the one or items, and initiating a period of time for use of the one or more items obtained from the device;
sending a confirmation message to the user;
wherein after the one or items is returned to the device, the item is received by the device, scanned and counted, and the user's account is disassociated from the one or more items returned to the device, thereby terminating the period of time for use of the one or more items, and wherein a further confirmation message is sent to the user.

13. The method of claim 12, wherein the request and confirmation messages are received through a user information on the device or through a mobile application.
